(19) United States
(12) Patent Application Publication
(10) Pub. No.: US 2025/0153635 A1
(43) Pub. Date: May 15, 2025

(54) VIRTUAL ENGINE SIGNAL SYSTEM FOR VEHICLE AND METHOD OF CONTROLLING THE SAME

(71) Applicants: Hyundai Motor Company, Seoul (KR); Kia Corporation, Seoul (KR)

(72) Inventor: Seok Hee JEONG, Hwaseong-si (KR)

(21) Appl. No.: 18/664,814

(22) Filed: May 15, 2024

(30) Foreign Application Priority Data
Nov. 14, 2023 (KR) 10-2023-0157541

(51) Int. Cl. B60Q 5/00; B60L 3/00; B60R 19/48; H04R 1/32

(52) U.S. Cl. CPC B60Q 5/008; B60L 3/0015; B60R 19/48; H04R 1/323; B60L 2270/42; H04R 2499/13

(57) ABSTRACT

A virtual engine signal system for a vehicle includes a first speaker provided on a front back beam of a vehicle, disposed to be directed toward a front side of the vehicle, and configured to output a virtual engine signal to the outside, a second speaker provided rearward of the first speaker, disposed to be directed toward a rear side of the vehicle, and configured to output a virtual engine signal to the outside, and a controller configured to transmit control signals to the first and second speakers so that the first and second speakers output the virtual engine signals in response to the control signals, the controller being configured to control the first and second speakers to adjust sound pressures of synthetic signals of the virtual engine signals of the first and second speakers at the front and rear sides of the vehicle.

### CROSS-REFERENCE TO RELATED APPLICATION

The present application claims priority to Korean Patent Application No. 10-2023-0157541, filed on Nov. 14, 2023, the entire contents of which are incorporated herein for all purposes by this reference.

### TECHNICAL FIELD

The present disclosure relates to a virtual engine signal system for a vehicle and a method of controlling the same, and more particularly, to a virtual engine signal system for a vehicle and a method of controlling the same, which are capable of solving a problem with a beep sound while adjusting sound pressures of synthetic signals synthesized at front and rear sides of a vehicle.

### BACKGROUND

A virtual engine sound system (VESS) for a vehicle refers to a system equipped with a speaker mounted on a front back beam of a vehicle to output an artificial engine sound as an external sound. The VESS may be applied to an environmentally-friendly vehicle such as an electric vehicle and reduce the likelihood of an accident that may occur when a pedestrian cannot recognize the vehicle because the amount of noise is extremely small when a motor operates at low speed.

The VESS for a vehicle uses the mounted speaker in order to meet regulations and solve a constraint to an engine room space. In this case, in case that the VESS is positioned at a front side of the vehicle, there is a difference in sound pressure between synthetic signals measured at the front and rear sides of the vehicle.

Therefore, only a virtual engine signal is outputted when the vehicle travels forward, and both the virtual engine signal and a beep sound are outputted when the vehicle travels rearward, such that the difference in sound pressure between the synthetic signals may be solved. In this case, some people may dislike the beep sound outputted when the vehicle travels rearward.

In case that the VESS is additionally applied to the rear side of the vehicle in order to solve the problem with the beep sound outputted when the vehicle travels rearward, costs increase because of the addition of hardware and controllers and a constraint to a space occurs.

Therefore, there is a need for a solution to configure a system for solving the problem with the beep sound while adjusting sound pressures of the synthetic signals synthesized at the front and rear sides of the vehicle.

The foregoing explained as the background is intended merely to aid in the understanding of the background of the present disclosure, and is not intended to mean that the present disclosure falls within the purview of the related art that is already known to those skilled in the art.

### SUMMARY

The present disclosure describes a virtual engine signal system for a vehicle and a method of controlling the same, which are capable of solving a problem with a beep sound while adjusting sound pressures of synthetic signals synthesized at front and rear sides of a vehicle.

In order to achieve the technical object, the present disclosure provides a virtual engine signal system for a vehicle, the virtual engine signal system including: a first speaker provided on a front back beam of a vehicle, disposed to be directed toward a front side of the vehicle, and configured to output a virtual engine signal to the outside; a second speaker provided rearward of the first speaker, disposed to be directed toward a rear side of the vehicle, and configured to output a virtual engine signal to the outside; and a controller configured to transmit control signals to the first and second speakers so that the first and second speakers output the virtual engine signals in response to the control signals, the controller being configured to control the first and second speakers to adjust sound pressures of synthetic signals of the virtual engine signals of the first and second speakers at the front and rear sides of the vehicle.

For example, the first speaker may be a directional speaker configured to output the virtual engine signal toward one side, and the second speaker may be an omnidirectional speaker configured to output the virtual engine signal toward two opposite sides.

For example, the second speaker may be provided rearward of the first speaker and disposed adjacent to the first speaker.

For example, the controller may set a reference level corresponding to an engine signal capable of being recognized by pedestrians at the front and rear sides of the vehicle, and the controller may transmit the control signals to the first and second speakers depending on the set reference level.

For example, the controller may determine the control signal to be transmitted to the first speaker so that the virtual engine signal outputted by the first speaker is smaller in magnitude than the set reference level, and a phase of the virtual engine signal is inverted.

For example, the controller may determine the control signal to be transmitted to the second speaker so that the virtual engine signal outputted by the second speaker is larger in magnitude than the set reference level.

For example, the controller may determine the control signals for the first and second speakers based on a distance between the front back beam of the vehicle and the front or rear side of the vehicle.

For example, the controller may determine the control signals for the first and second speakers so that the sound pressures of the synthetic signals at the front and rear sides of the vehicle are equal to each other.

In order to achieve the technical object, the present disclosure provides a method of controlling a virtual engine signal for a vehicle including a first speaker provided on a front back beam of a vehicle, disposed to be directed toward a front side of the vehicle, and configured to output a virtual engine signal to the outside, and a second speaker provided rearward of the first speaker, disposed to be directed toward a rear side of the vehicle, and configured to output a virtual engine signal to the outside, the method including: transmitting control signals to the first and second speakers; outputting, by the first and second speakers, the virtual engine signals in response to the control signals; and adjusting sound pressures of synthetic signals of the virtual engine signals of the first and second speakers at the front and rear sides of the vehicle.

For example, the transmitting of the control signals to the first and second speakers may include: setting a reference level corresponding to an engine signal capable of being recognized by pedestrians at the front and rear sides of the vehicle; and transmitting the control signals to the first and second speakers depending on the set reference level.

For example, the method may further include: determining the control signal to be transmitted to the first speaker so that the virtual engine signal outputted by the first speaker is smaller in magnitude than the preset reference level, and a phase of the virtual engine signal is inverted.

For example, the method may further include: determining the control signal to be transmitted to the second speaker so that the virtual engine signal outputted by the second speaker is larger in magnitude than the set reference level.

For example, the method may further include: determining the control signals for the first and second speakers based on a distance between the front back beam of the vehicle and the front or rear side of the vehicle.

According to the virtual engine signal system for a vehicle and the method of controlling the same according to the present disclosure, it may be possible to adjust the sound pressures of the synthetic signals made by synthesizing the virtual engine signals outputted by the first and second speakers even when the first and second speakers are provided at one side of the vehicle.

The effects capable of being obtained by the present disclosure are not limited to the aforementioned effects, and other effects, which are not mentioned above, will be clearly understood by those skilled in the art from the following description.

### BRIEF DESCRIPTION OF THE DRAWINGS

FIG. 1 is a block diagram illustrating an example of a virtual engine signal system for a vehicle.

FIG. 2 is a view illustrating an example of sound pressures of virtual engine signals outputted by first and second speakers.

FIG. 3 is a view illustrating an example of sound pressures of synthetic signals of virtual engine signals of the first and second speakers.

FIG. 4 is a flowchart an example of a method for controlling a virtual engine signal for a vehicle.

### DETAILED DESCRIPTION

Hereinafter, one or more implementations disclosed in the present specification will be described in detail with reference to the accompanying drawings. The same or similar constituent elements are assigned with the same reference numerals regardless of reference numerals, and the repetitive description thereof will be omitted.

In this disclosure, the term “control unit” or “unit” included in the name of “motor control unit (MCU)” or “hybrid control unit (HCU)” is merely a term widely used to name a control device (controller or control unit) for controlling a particular vehicle function but does not mean a generic function unit.

A controller may include a communication device configured to communicate with another control unit or a sensor to control a corresponding function, a memory configured to store an operating system, a logic instruction, and input/output information, and one or more processors configured to perform determination, computation, decision, or the like required to control the corresponding function.

In some implementations, even when first and second speakers are provided at one side of a vehicle, sound pressures of synthetic signals made by synthesizing virtual engine signals outputted by the speakers may be adjusted.

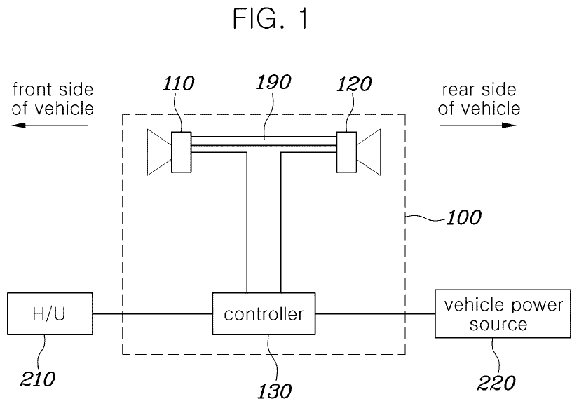

FIG. 1 is a block diagram illustrating an example of a virtual engine signal system for a vehicle. FIG. 1 is mainly focused on constituent elements related to the present implementation. However, an actual configuration of the virtual engine signal system for a vehicle may, in some examples, include more or fewer constituent elements.

In some implementations, with reference to FIG. 1, a virtual engine signal system 100 for a vehicle may include a first speaker 110, a second speaker 120, and a controller 130.

Both the first speaker 110 and the second speaker 120 may be provided on a front back beam 190 of a vehicle. The first speaker 110 and the second speaker 120 may be respectively disposed to face front and rear sides of the vehicle and output virtual engine signals to the outside. In addition, the second speaker 120 may be provided rearward of the first speaker 110 and disposed adjacent to the first speaker 110. This is to prevent the occurrence of a phase difference between the virtual engine signals outputted by the speakers. An ideal distance between the speakers may be 0 mm. In this case, all the first speaker 110, the second speaker 120, and the controller 130 may be inserted into a housing.

In addition, the controller 130 may operate by receiving electric power from a vehicle power source 220. The controller 130 may be connected to an electrical component (e.g., head unit “H/U”) 210 of the vehicle and controlled as a user manipulates the electrical component. The controller 130 may transmit corresponding control signals to the first speaker 110 and the second speaker 120 so that the first speaker 110 and the second speaker 120 output the virtual engine signals in response to the control signals. In this case, the synthetic signals are made by synthesizing the virtual engine signals outputted by the first speaker 110 and the second speaker 120, and the controller 130 may adjust the sound pressures of the synthetic signals at the front and rear sides of the vehicle.

More specifically, the controller 130 may set a reference level corresponding to an engine signal that may be recognized by pedestrians at the front and rear sides of the vehicle. The pedestrian may recognize the outputted engine signal corresponding to the reference level, which may improve the safety of the pedestrian. The controller 130 may transmit the control signals to the first speaker 110 and the second speaker 120 depending on the set reference level.

The control signals, which are to be transmitted to the first speaker 110 and the second speaker 120, are determined as follows. The control signal, which is to be transmitted to the first speaker 110 by the controller 130, may be determined so that the virtual engine signal outputted by the first speaker 110 is smaller in magnitude than the set reference level, and a phase of the virtual engine signal is inverted. The control signal, which is to be transmitted to the second speaker 120, may be determined so that the virtual engine signal outputted by the second speaker 120 is larger in magnitude than the set reference level, and a phase of the virtual engine signal is not inverted.

This is to adjust the sound pressures of the synthetic signals of the virtual engine signals outputted by the first speaker 110 and the second speaker 120, and the control signals may be determined based on a distance between the front back beam 190 of the vehicle and the front side of the vehicle or the rear side of the vehicle.

In this case, the sound pressure of the synthetic signal of the virtual engine signal at the front side of the vehicle may be calculated on the basis of the following expression.

A (sound pressure of synthetic signal at front side of vehicle): 10 log((75+Y))/10−(75−X)/10))

In this case, assuming that the reference level is 75 dB, X represents a level difference that allows the magnitude of the virtual engine signal outputted by the first speaker 110 to have a level smaller than 75 dB, i.e., the reference level, and Y represents a level difference that allows the magnitude of the virtual engine signal outputted by the second speaker 120 to have a level larger than 75 dB, i.e., the reference level. Further, the controller 130 may determine Y as a value larger than X so that the sound pressures of the synthetic signals at the front and rear sides of the vehicle are equal to each other.

In addition, the sound pressure of the synthetic signal of the virtual engine signal at the rear side of the vehicle may be calculated on the basis of the following expression.

B (sound pressure of synthetic signal at rear side of vehicle):A (sound pressure of synthetic signal at front side of vehicle)−20 log(L1/L2)

In this case, L1 represents a distance from the virtual engine signal system 100 for a vehicle positioned on the front back beam 190 to the front side of the vehicle, and L2 represents a distance from the virtual engine signal system 100 for a vehicle positioned on the front back beam 190 to the rear side of the vehicle.

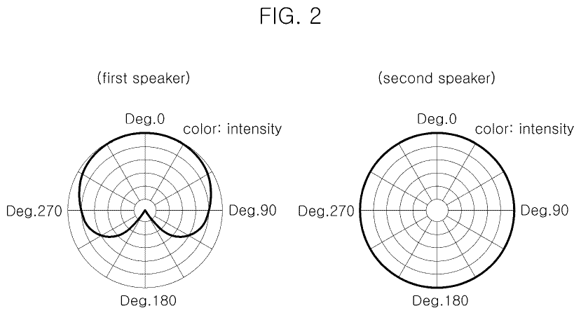

In this case, the first speaker 110 may be configured as a directional speaker, and the second speaker 120 may be configured as an omnidirectional speaker. This configuration will be described with reference to FIG. 2.

FIG. 2 is a view illustrating the sound pressures of the virtual engine signals outputted by the first speaker 110 and the second speaker 120.

As illustrated in the left side of FIG. 2, the directional speaker may output the virtual engine signal toward one side, and as illustrated in the right side of FIG. 2, the omnidirectional speaker may output the virtual engine signal toward two opposite sides. The directional speaker is characterized in that the signal outputted by the directional speaker has a high sound pressure at a particular angle and a low sound pressure at another particular angle. The omnidirectional speaker is characterized by being capable of outputting the signals having the same sound pressure at any angle.

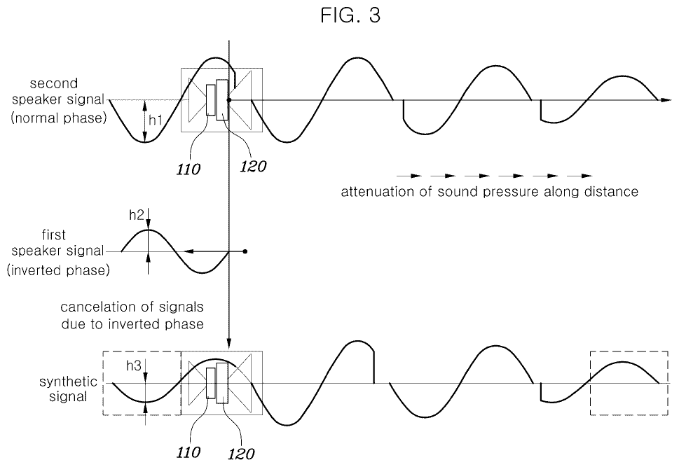

FIG. 3 is a view illustrating the sound pressures of the synthetic signals of the virtual engine signals of the first and second speakers 110 and 120.

FIG. 3 is a view illustrating a state in which the first and second speakers output the virtual engine signals in the structure in which the first speaker 110 is disposed to be directed toward the front side of the vehicle and the second speaker 120 is disposed to be directed toward the rear side of the vehicle.

From the top side of FIG. 3, FIG. 3 illustrates a waveform of a signal outputted by the second speaker 120, a waveform of a signal outputted by the first speaker 110, and a waveform of a synthetic signal made by synthesizing the signals outputted by the speakers. The signals are canceled when the signals have opposite phases, and the signals are reinforced when the signals have the same phase. When an amplitude of the virtual engine signal outputted by the second speaker 120 is h1 (negative value) and an amplitude of the virtual engine signal outputted by the first speaker 110 is h2 (positive value), a signal amplitude of the synthetic signal of the virtual engine signals of the first speaker 110 and the second speaker 120 is h3=h1+h2.

As described above, the directional speaker, which outputs the signal at the particular angle, is disposed to be directed toward the front side of the vehicle, and the omnidirectional speaker, which outputs the same signal at any angle, is disposed to be directed toward the rear side of the vehicle, such that the sound pressure of the synthetic signal of the virtual engine signal at the rear side of the vehicle may be set to be equal to the sound pressure at the front side of the vehicle.

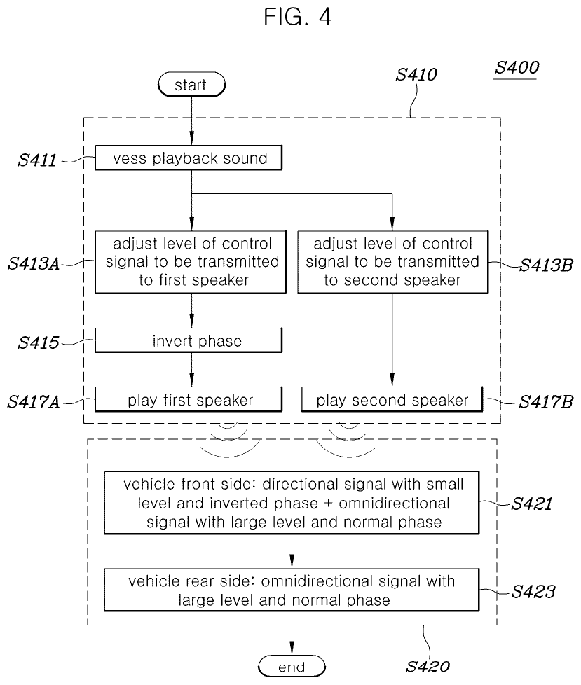

A method of controlling a virtual engine signal for a vehicle will be described with reference to FIG. 4 on the basis of the configuration of the virtual engine signal system 100 for a vehicle.

FIG. 4 is a flowchart S400 for explaining a method of controlling a virtual engine signal for a vehicle.

With reference to FIG. 4, first, the method of controlling a virtual engine signal for a vehicle may be divided into a digital region S410 and a sound region S420. The digital region will be described first. The controller 130 may set the reference level corresponding to the engine signal that may be recognized by the pedestrians at the front and rear sides of the vehicle (S411).

The controller 130 may transmit the control signals to the first speaker 110 and the second speaker 120 depending on the set reference level. The control signals, which are to be transmitted to the first speaker 110 and the second speaker 120, are determined as follows. The control signal, which is to be transmitted to the first speaker 110 by the controller 130, may be determined so that the virtual engine signal outputted by the first speaker 110 is smaller in magnitude than the set reference level, and the phase of the virtual engine signal is inverted (S413A and S415).

In addition, the control signal, which is to be transmitted to the second speaker 120, may be determined so that the virtual engine signal outputted by the second speaker 120 is larger in magnitude than the set reference level, and the phase of the virtual engine signal is not inverted (S413B). Therefore, the first speaker 110 and the second speaker 120 may output the virtual engine signals in response to the control signals (S417A and S417B).

Thereafter, in the sound region S420, the virtual engine signal outputted by the first speaker 110 and having the inverted phase and the virtual engine signal outputted by the second speaker 120 are canceled at the front side (front surface) of the vehicle, and the virtual engine signal outputted by the second speaker 120 attenuates gradually along the distance at the rear side (rear surface) of the vehicle.

In some implementations, it may be possible to adjust the sound pressures of the synthetic signals made by synthesizing the virtual engine signals outputted by the first and second speakers even when the first and second speakers are provided at one side of the vehicle.

While the specific implementations of the present disclosure have been illustrated and described, it will be obvious to those skilled in the art that the present disclosure may be variously modified and changed without departing from the technical spirit of the present disclosure defined in the appended claims.

What is claimed is:

1. A virtual engine signal system for a vehicle, the virtual engine signal system comprising:
a first speaker disposed at a front back beam of the vehicle, the first speaker being oriented toward a front side of the vehicle and configured to output a first virtual engine signal to an outside of the vehicle;
a second speaker disposed rearward relative to the first speaker, the second speaker being oriented toward a rear side of the vehicle and configured to output a second virtual engine signal to the outside; and
a controller configured to transmit first and second control signals to the first and second speakers to thereby cause the first and second speakers to output the first and second virtual engine signals in response to the first and second control signals, respectively,
wherein the controller is configured to control the first and second speakers to adjust sound pressures of synthetic signals of the first and second virtual engine signals of the first and second speakers at the front and rear sides of the vehicle, respectively.

2. The virtual engine signal system of claim 1, wherein the first speaker comprises a directional speaker that is configured to output the first virtual engine signal toward one side thereof, and
wherein the second speaker comprises an omnidirectional speaker that is configured to output the second virtual engine signal toward two opposite sides thereof.

3. The virtual engine signal system of claim 1, wherein the second speaker is disposed adjacent to the first speaker.

4. The virtual engine signal system of claim 1, wherein the controller is configured to:
set a reference level corresponding to an engine signal capable of being recognized by a pedestrian at the front or rear side of the vehicle; and
transmit the first and second control signals to the first and second speakers, respectively, based on the reference level.

5. The virtual engine signal system of claim 4, wherein the controller is configured to determine the first control signal to be transmitted to the first speaker to thereby cause the first speaker to output the first virtual engine signal having (i) a magnitude that is less than the reference level and (ii) a phase that is inverted with respect to the second virtual engine signal.

6. The virtual engine signal system of claim 4, wherein the controller is configured to determine the second control signal to be transmitted to the second speaker to thereby cause the second speaker to output the virtual engine signal having a magnitude that is greater than the reference level.

7. The virtual engine signal system of claim 1, wherein the controller is configured to determine the first and second control signals for the first and second speakers, respectively, based on a distance between the front back beam of the vehicle and the front or rear side of the vehicle.

8. The virtual engine signal system of claim 7, wherein the controller is configured to determine the first and second control signals to thereby cause the sound pressures of the synthetic signals at the front and rear sides of the vehicle to be equal to each other.

9. A method for controlling a virtual engine signal for a vehicle, the vehicle including (i) a first speaker disposed at a front back beam of the vehicle, the first speaker being oriented toward a front side of the vehicle and configured to output a first virtual engine signal to an outside of the vehicle, and (ii) a second speaker disposed rearward relative to the first speaker, the second speaker being oriented toward a rear side of the vehicle and configured to output a second virtual engine signal to the outside, the method comprising:
transmitting first and second control signals to the first and second speakers, respectively;
outputting, by the first and second speakers, the first and second virtual engine signals in response to the first and second control signals, respectively; and
adjusting sound pressures of synthetic signals of the first and second virtual engine signals of the first and second speakers at the front and rear sides of the vehicle, respectively.

10. The method of claim 9, wherein transmitting the first and second control signals to the first and second speakers comprises:
setting a reference level corresponding to an engine signal capable of being recognized by a pedestrian at the front or rear side of the vehicle; and
transmitting the first and second control signals to the first and second speakers, respectively, based on the reference level.

11. The method of claim 10, further comprising:
determining the first control signal to be transmitted to the first speaker to thereby cause the first speaker to output the first virtual engine signal having (i) a magnitude that is less than the reference level and (ii) a phase that is inverted with respect to the second virtual engine signal.

12. The method of claim 10, further comprising:
determining the second control signal to be transmitted to the second speaker to thereby cause the second speaker to output the virtual engine signal having a magnitude that is greater than the reference level.

13. The method of claim 9, further comprising:
determining the first and second control signals for the first and second speakers, respectively, based on a distance between the front back beam of the vehicle and the front or rear side of the vehicle.
